(19) United States
(12) Patent Application Publication
(10) Pub. No.: US 2018/0352198 A1
(43) Pub. Date: Dec. 6, 2018

(54) PATTERN DETECTION TO DETERMINE CARGO STATUS

(71) Applicant: Spireon, Inc., Irvine, CA (US)

(72) Inventors: Charles Frederick Raasch, Foothill Ranch, CA (US); Edward Suski, Mission Viejo, CA (US)

(73) Assignee: Spireon, Inc., Irvine, CA (US)

(21) Appl. No.: 15/728,836

(22) Filed: Oct. 10, 2017

Related U.S. Application Data
(60) Provisional application No. 62/515,280, filed on Jun. 5, 2017.

(51) Int. Cl. H04N 7/18; G06K 9/00; G06K 9/62

(52) U.S. Cl. CPC H04N 7/188; G06K 9/6212; G06K 9/00771; H04N 7/181

(57) ABSTRACT

A cargo sensor system uses reflective patterns on the back door of a cargo trailer that are easily recognized by a camera mounted in the nose of the trailer. Preferred embodiments rely on the assumption that if cargo has been loaded into a trailer, that cargo will be present on the floor of the trailer, no matter whether the trailer was loaded from front to back, or from back to front. Looking across the floor at a relatively low height toward the door having the reflective pattern at a low height, any cargo on the floor will interrupt the camera's vision of the pattern, by which it can be inferred that there is cargo on the floor of the trailer.

### RELATED APPLICATIONS

This nonprovisional application claims priority to provisional patent application Ser. No. 62/515,280 filed Jun. 5, 2017, titled Pattern Detection to Determine Cargo Status, the entire contents of which are incorporated herein by reference.

### FIELD

This invention relates to the field of cargo transportation. More particularly, this invention relates to a system for sensing the load status of a cargo container, such as a cargo trailer.

### BACKGROUND

Previous optical solutions for determining the load status of a cargo container have relied on having a reference image for comparison purposes. Obtaining a reference image requires that the container be empty in order to capture that image. This can be problematic if no reference image was captured prior to loading the container.

Previous optical solutions that do not rely on a reference image rely instead on the geometry of the installation of optical sensors. In such systems, any issues with the sensor installation can result in errant results.

What is needed, therefore, is a cargo sensor system that can be used on a loaded trailer or other container to detect whether the trailer is empty or not empty without having to rely on a reference image. Also needed is a cargo sensor system that addresses the shortcomings in the sensor arrangements of prior optical cargo detection systems.

### SUMMARY

The above and other needs are met by a cargo sensor system that uses reflective patterns on the back door of a cargo trailer that are easily recognized by a camera mounted in the nose of the trailer. These patterns may be of many types, but are specific so they are easily recognized. Preferred embodiments of the invention rely on the assumption that if cargo has been loaded into a trailer, that cargo will be present on the floor of the trailer, no matter whether the trailer was loaded from front to back, or from back to front. Looking across the floor at a relatively low height toward the door having the reflective pattern at a low height, any cargo on the floor will interrupt the camera's vision of the pattern, by which it can be inferred that there is cargo on the floor of the trailer.

In some preferred embodiments, a camera mounted at the nose of the trailer includes an illuminator. The illuminator can be in any spectrum, but in preferred embodiments is in the visible or infrared spectrum. In preferred embodiments, a microcontroller or computer system is coupled to the camera and illuminator, and controls the camera and illuminator. In preferred embodiments, the reflective pattern is mounted on the doors of the trailer, or on the lintels of the door of the trailer. In preferred embodiments, the computer system uses standard image processing techniques, which may include contrast enhancement, thresholding, edge detection, and other image manipulation techniques to determine the presence or absence of the reflective patterns. In preferred embodiments, the patterns may include reflective tape, retroreflective tape, reflective paint, illuminators such as LEDs, or combinations of thereof. In preferred embodiments, the patterns may be dots, stripes, boxes, or other patterns that may be extracted from an image captured by said camera coupled to said computer system. In preferred embodiments, the computer system may be a microcontroller, or may be a computer system running an operating system such as Linux or other embedded operating system. In preferred embodiments, the reflective patterns may be of different colors or shapes depending on their locations. In other preferred embodiments, the reflective pattern may extend around the perimeter of the inside of the trailer. In such embodiments, a wide-angle camera connected to said computer system may detect an interruption between the camera and the reflective pattern to provide more comprehensive coverage of the trailer. In a preferred embodiment, the image is captured at the trailer, but sent over a network to a remote site to be processed at that remote site to determine the location of the reflectors and cargo status of the trailer.

In one embodiment, the invention provides method for detecting cargo within an interior space of a cargo container. The method of this embodiment includes the following steps:
(a) installing one or more imaging sensors within the cargo container, each having a field of view directed to the interior space;
(b) providing a pattern of reflective elements on an interior surface of the cargo container, the pattern comprising n number of reflective elements that are within the field of view of at least one of the one or more imaging sensors;
(c) capturing a digital image of the interior space of the cargo container, the digital image including a first portion of the interior space that includes the pattern of reflective elements, the digital image comprising pixels arranged in an x-direction and a y-direction, each pixel having an amplitude;
(d) detecting a maximum amplitude value of the amplitudes of the pixels in the digital image, and determining a threshold amplitude value based on the maximum amplitude value;
(e) applying a threshold filter to the digital image based on the threshold amplitude value to generate a threshold-filtered image;
(f) determining how many of the n number of reflective elements of the pattern are detected in the threshold-filtered image; and
(g) if fewer than n number of reflective elements are detected in the threshold-filtered image, generating a notification indicating that cargo is present within the interior space of the cargo container.

In some embodiments, the reflective elements comprise dots or lines or a combination of dots and lines.

In some embodiments, the first portion of the interior space comprises a center portion of the cargo container.

In some embodiments, step (d) comprises determining the threshold amplitude value to be equivalent to the maximum amplitude value.

In some embodiments, step (e) comprises setting the amplitudes of all pixels having amplitudes that are greater than or equal to the threshold amplitude value to a high value, and setting the amplitudes of all pixels having amplitudes that are less than the threshold amplitude value to a low value.

In some embodiments, if it is determined that all of the n number of reflective elements are detected in the threshold-filtered image, the method further comprises:
(h) masking the first portion of the digital image;
(i) creating an intensity histogram of the digital image, excluding the first portion;
(j) locating a valley in the intensity histogram and detecting a valley amplitude value in the valley;
(k) applying a threshold filter to the digital image based on the valley amplitude value to generate a threshold-filtered image in which the amplitude of each pixel that is greater than or equal to the valley amplitude value is set to a high amplitude value;
(l) assembling pixels in the threshold-filtered image into groups, wherein each pixel in each group has the high amplitude value and is adjacent in either the x-direction or y-direction to at least one other pixel having the high amplitude value;
(m) for each group, determining a first number of pixels that are adjacent to at least one other pixel in the x-direction, and determining a second number of pixels that are adjacent to at least one other pixel in the y-direction;
(n) determining whether one or both of the first number of pixels and the second number of pixels is greater than a threshold number; and
(o) if one or both of the first number of pixels and the second number of pixels is greater than the threshold number, generating a notification indicating that cargo is present within the interior space of the cargo container.

In some embodiments, if it is determined that all of the n number of reflective elements are detected in the threshold-filtered image, the method further comprises:
(h) masking the first portion of the digital image;
(i) selecting a pixel of the plurality of pixels that is outside the first portion of the digital image and has not been previously selected;
(j) averaging the amplitude values of all pixels in a block of pixels disposed below and adjacent to a location of the selected pixel to determine a first average amplitude value;
(k) averaging the amplitude values of all pixels in a block of pixels disposed above and adjacent to the location of the selected pixel to determine a second average amplitude value;
(l) if a difference between the first average amplitude value and the second average amplitude value is greater than or equal to a threshold value, setting the amplitude value of the selected pixel to a high amplitude value;
(m) repeating steps (i)-(l) until all of the plurality of pixels that are outside the first portion of the digital image have been selected;
(n) assembling the selected pixels having the high amplitude value into groups, wherein each selected pixel in each group is adjacent in either the x-direction or y-direction to at least one other selected pixel having the high amplitude value;
(o) determining whether a number of selected pixels in any of the groups assembled in step (n) is greater than a threshold number; and
(p) if the number of selected pixels in any of the groups assembled in step (n) is greater than the threshold number, generating a notification indicating that cargo is present within the interior space of the cargo container.

In some embodiments, the blocks of pixels disposed below and above the location of the selected pixel each comprises an N+1 by N/2 block of pixels, where N is an integer value greater than one.

### BRIEF DESCRIPTION OF THE DRAWINGS

Other embodiments of the invention will become apparent by reference to the detailed description in conjunction with the figures, wherein elements are not to scale, so as to more clearly show the details, wherein like reference numbers indicate like elements throughout the several views, and wherein:

FIG. 1 depicts a cargo sensing system according to an embodiment of the invention;

FIG. 2 depicts a typical cargo trailer attached to a tractor;

FIGS. 3-7 depict images of exemplary reflective patterns on the interior of a trailer door according to embodiments of the invention;

FIGS. 8-11 depict field-of-view geometries for various camera placement options in a trailer;

FIGS. 12A and 12B depict a flowchart of a cargo detection algorithm according to a preferred embodiment;

FIGS. 13-16 depict exemplary images used in cargo detection in side areas of a trailer according to embodiments of the invention;

FIG. 17 depicts an exemplary intensity histogram of an image of one side of the interior of a cargo trailer in which cargo is present; and

FIG. 18 depicts a representation of a region of pixels in an image.

### DETAILED DESCRIPTION

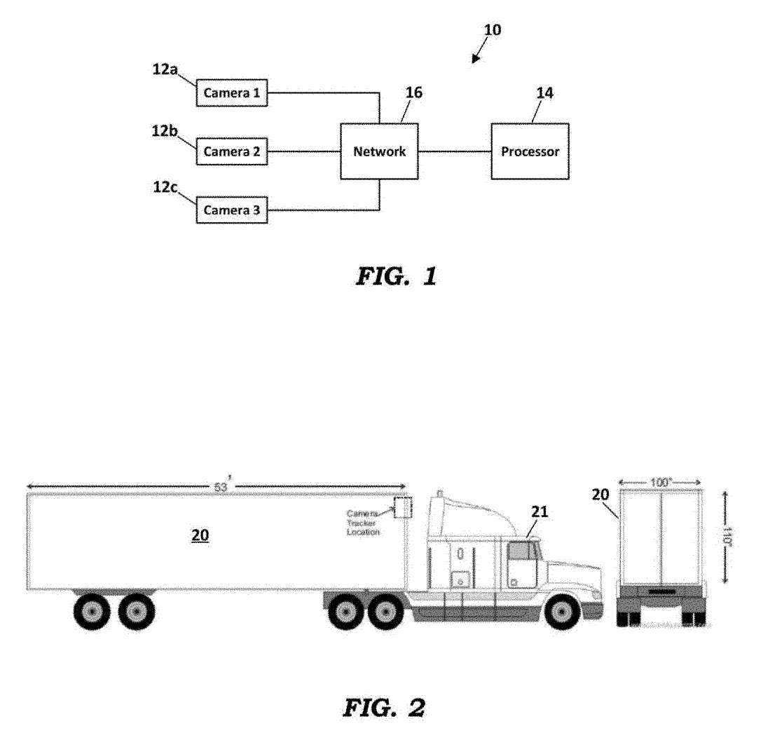

FIG. 1 depicts an embodiment of a cargo sensing system 10. Generally, the system 10 includes one or more imaging sensors 12a-12c, such as cameras, installed in a cargo container, such as the trailer 20 depicted in FIG. 2, with their fields of view directed to the interior of the trailer 20 as described in more detail hereinafter. Digital images generated by the sensors 12a-12c are provided to a processor 14 for processing as described below. The processor 14 may be located in or on the trailer 20, or the processor 14 may be in a location remote from the trailer. In either case, the sensors 12a-12c preferably communicate with the processor 14 through a network 16, which may be a local network in the trailer 20, a wireless data communication network, the Internet, or a combination of such networks. The sensors 12a-12c may also communicate with the processor 14 directly through a serial or parallel interface. Each sensor 12a-12c may also have a local processor that communicates with processors of other sensors through a network or series of serial ports.

Door Patterns—Center Detection

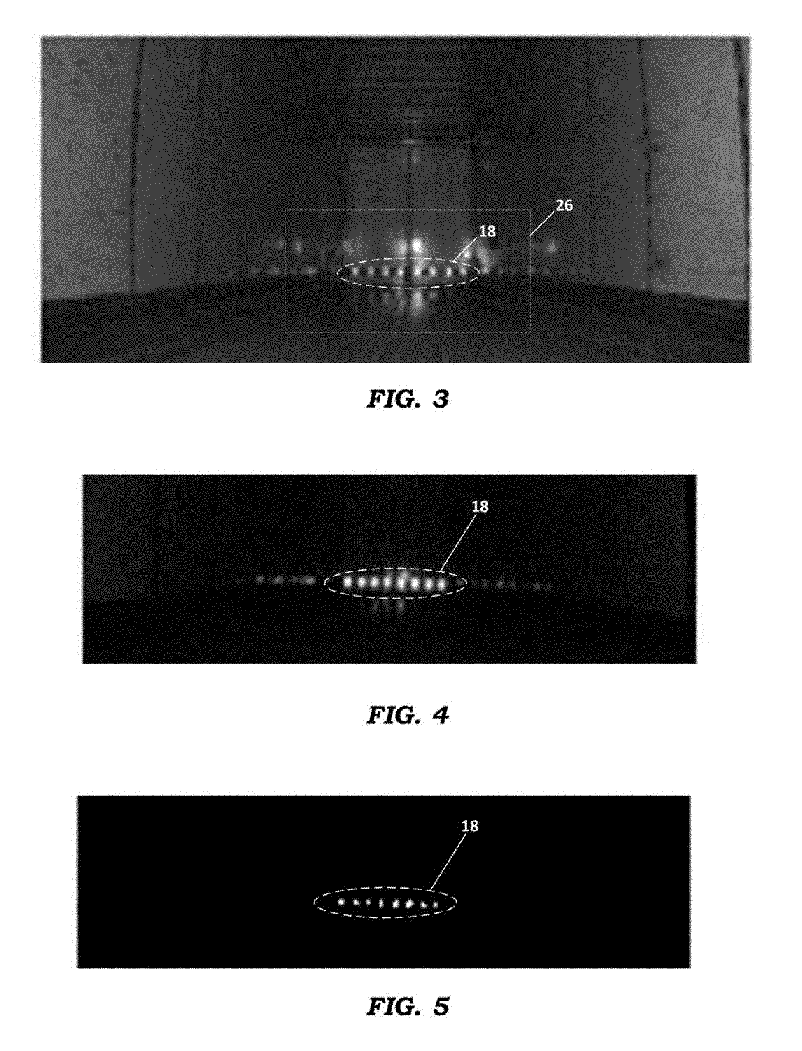

FIG. 3 depicts a graphical representation of a camera image of a pattern 18 of reflective elements on a door of a trailer. Although the pattern 18 shown in FIG. 3 is an array of dots, one of skill in the art will appreciate that the pattern may comprise any specific arrangement of dots, lines, or other shapes that may be extracted by image processing methods. The pattern 18 may comprise reflective elements of various colors, and in alternating patterns of different colors. The image shown in FIG. 3 was generated using a camera mounted sixteen inches above the floor at the nose of the trailer, with illumination provided by an infrared 5 W 9-LED floodlight.

The exemplary pattern 18 shown in FIG. 3 was formed using reflective tape. A retro-reflective material could also be used to reduce the illumination power needed and increase the contrast of the pattern 18 compared to the background. Greater contrast increases detection accuracy and simplifies the image processing. FIG. 4 depicts a graphic representation of an image of a pattern 18 of eight retro-reflective dots on the same trailer door, in which the illumination is provided by an infrared 500 mW 2-LED light. Even though the illumination power has been significantly reduced, the eight dots clearly stand out, which simplifies the image processing.

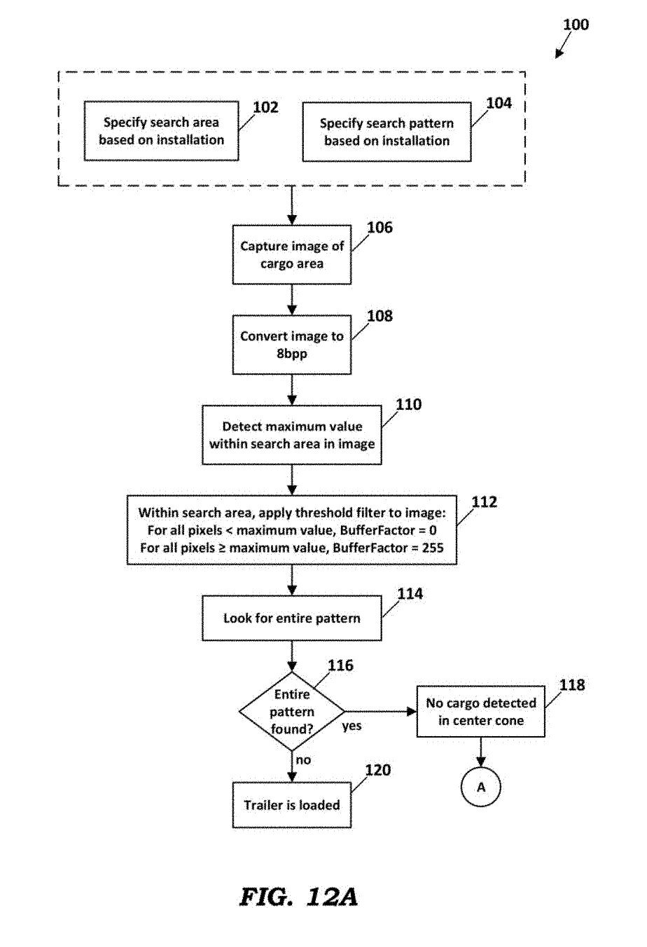

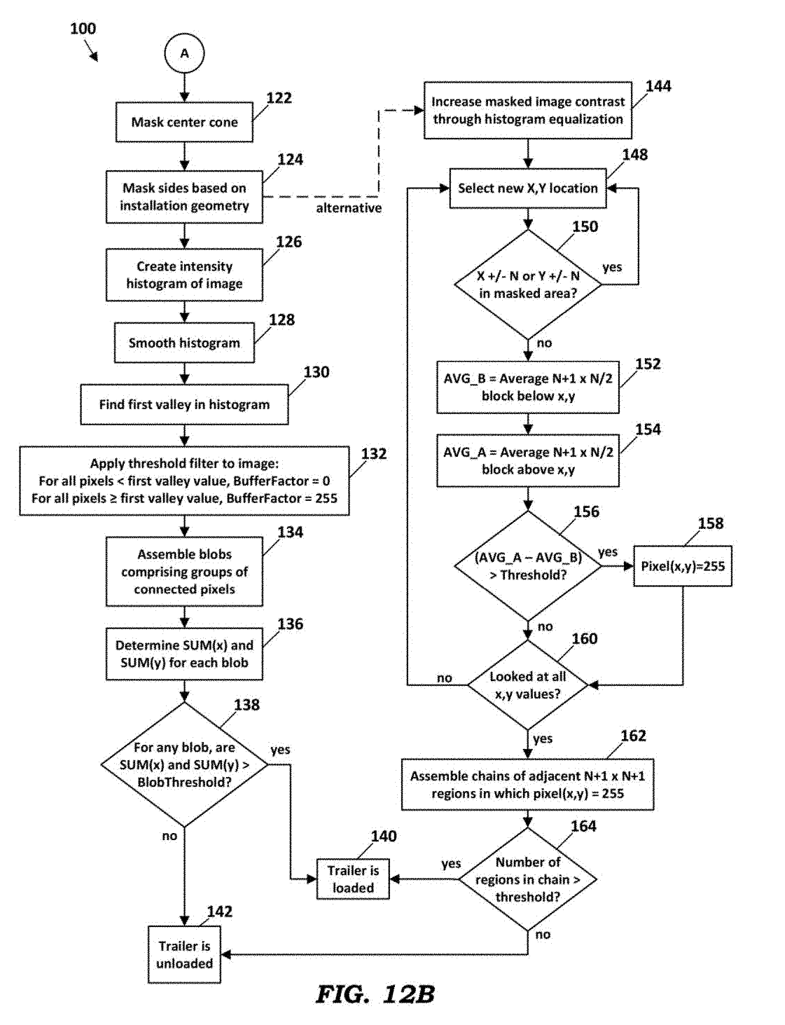

In a preferred embodiment, the processor 14 executes an image processing routine 100 represented by the flowchart depicted in FIGS. 12A and 12B. Prior to execution of the routine, certain parameters are specified that depend to some degree on the geometry of the trailer and the installation of the cameras. For example, a search area is specified (step 102), which is an area within a camera image where the search pattern 18 is expected to appear. In the image of FIG. 3, the search area may include the rectangular region 26. It will be appreciated that the search area may have any shape, and is not limited to rectangular. The search pattern 18 is also specified (step 104), which indicates the number and arrangement of dots, lines or other features that the image processing routine is seeking to detect in the image. These parameters are preferably stored in memory and used for each image processed until a change is needed due to a change in the pattern or positioning of cameras. For example, the search pattern may consist of a collinear arrangement of eight dots as shown in FIG. 3.

In a preferred embodiment, after an image of the cargo area of the trailer 20 is captured using a centrally-mounted one of the cameras 12a-12c (step 106), the image is converted to an 8 bits/pixel format (step 108) and the maximum value within the search area of the captured image is determined (step 110). A threshold function is then applied to all pixels within the search area using a predetermined threshold value that is equal to or less than the maximum value (step 112). For example, all pixels having amplitude values less than the maximum value are set to a low value (such as zero), and all pixels having amplitude values greater than or equal to the maximum value are set to a high value (such as 255). As depicted in FIG. 5, the pattern 18 is more distinct and thus easier to detect in the resulting threshold-filtered image. In a preferred embodiment, the raw image may be equalized using histogram equalization or other methods well known in the art, which would allow the thresholds to be more readily determined.

If cargo is present in the trailer 20 between the camera and the pattern 18 on the door, the field of view between the camera and the pattern 18 will be interrupted. Accordingly, the image processing routine detects either a portion of the pattern 18 or the entire pattern 18 in the threshold-filtered image (step 114). If the entire pattern 18 is detected (step 116), the routine generates a flag indicating that there is no cargo within the field of view of the centrally-mounted camera (step 118), which is also referred to herein as the “center cone” of the trailer 20. If less than the entire pattern 18 is detected, the routine generates a flag indicating that there is cargo present within the center cone of the trailer 20 (step 120).

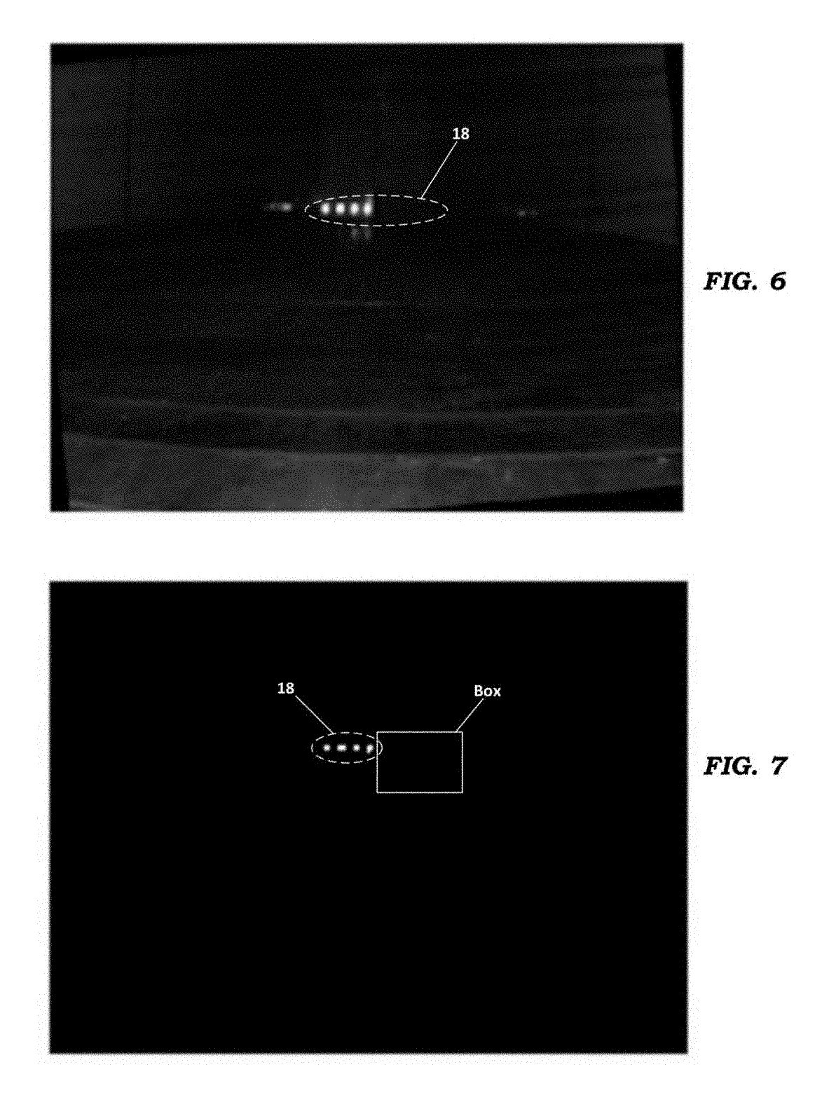

For example, FIG. 6 depicts a graphic representation of a raw (unfiltered) image of the center cone area of a trailer having a small box disposed halfway between the door and the camera. FIG. 7 depicts a graphic representation of a threshold-filtered version of the same image. Four of the eight dots in the pattern 18 are occluded by the box, indicating a “not empty” condition.

Side Detection

For a single camera disposed in the center of the trailer, the pattern monitoring method described above is highly robust, although it does not account for about half of the area of the trailer. Although the camera can see those areas, absent the reference pattern on the walls as described above, recognizing cargo in these areas falls on more traditional image processing and pattern recognition techniques.

The preferred algorithm described above with reference to FIG. 12A relies on relatively low illumination power necessary to find retroreflective dots on the trailer door. With this low illumination power, the sides of the trailer tend to disappear. In one preferred embodiment, when the routine of FIG. 12A has indicated that there is no cargo in the center cone of the trailer, the algorithms depicted in FIG. 12B can be used to detect cargo on the floor in areas on either side of the center cone. At step 122, the routine begins by masking out the center cone section of the image that was captured in step 106, including anything above the pattern on the door. The trailer side walls are then masked out, based on the known geometry of the placement of the camera, and known location of the pattern 18 near the bottom of the door (step 124).

Generally, this algorithm need not be carried out—and in fact the geometry may be difficult to determine—if the pattern on the door is not detected. Without detecting the pattern on the door, the location of the bottom of the door is unknown, making it difficult to build the geometric mask patterns. The geometric mask could be built on assumptions of the installation, however, as it is already known that there is cargo in the trailer based on the amount of the pattern that was not detected.

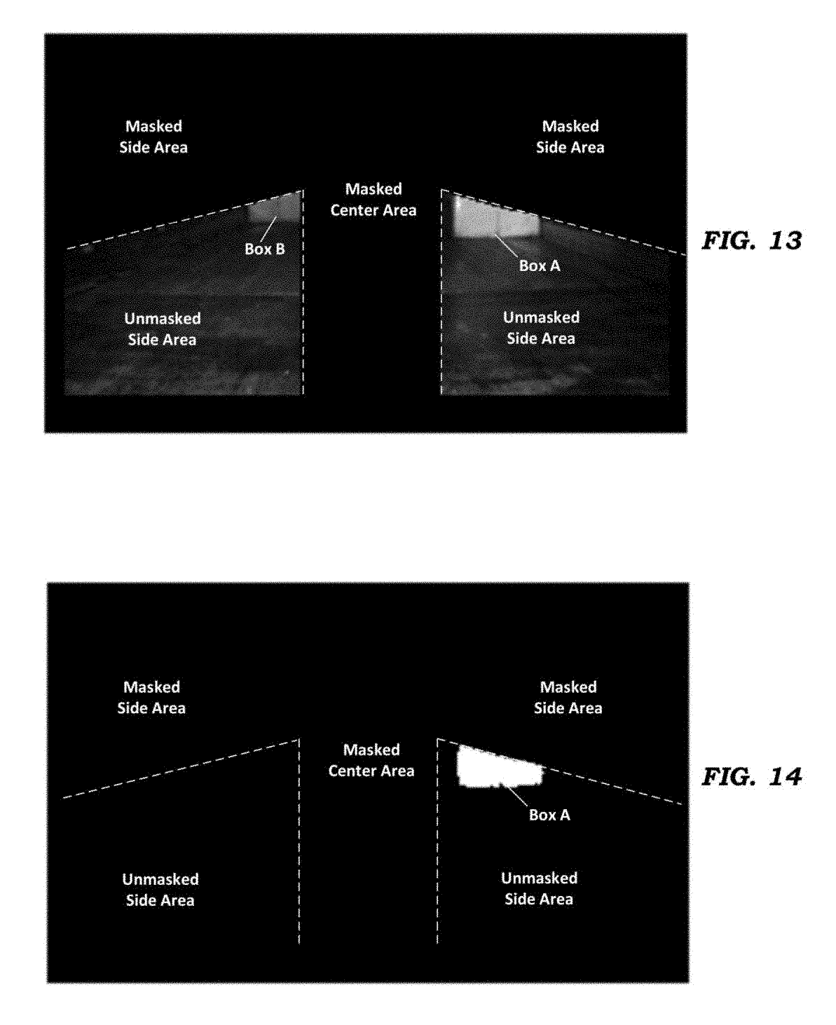

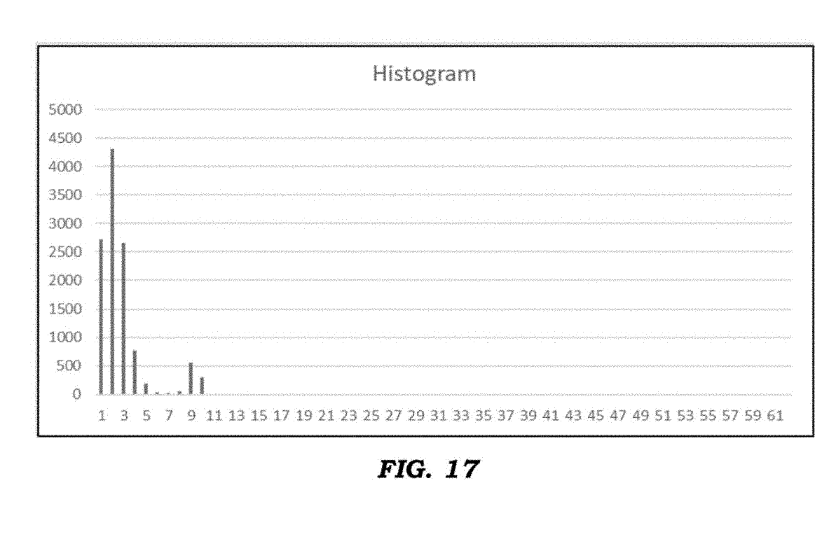

Steps 122 and 124 of FIG. 12B result in a masked image of the floor on the sides, where no cargo was detected by the algorithm of FIG. 12A. An example of such a masked image is depicted in FIG. 13. The image shows a box A on the right that is closer to the camera, and a box B on the left that is farther away. One or more algorithms are now be used to detect such boxes in the periphery. The algorithm of steps 126-132 treats each side area of the trailer separately, looking for pixels that are above a first peak level of an intensity histogram of the area. For example, FIG. 17 depicts an exemplary intensity histogram of the right half of the image shown in FIG. 13.

First, the intensity histogram of the image is created (step 126) and smoothed (step 128.) A first valley in the intensity histogram is then located (step 130) and a threshold filter is applied to the image based on the value of the first valley (step 132). For example, all pixels having amplitude values less than the value at the first valley are set to a low value (such as zero), and all pixels having amplitude values greater than or equal to the value at the first valley are set to a high value (such as 255).

As shown in FIG. 13, the difference in brightness of the cargo compared to the floor on the right side of the trailer is significant. This causes a peak in the histogram that is separated from the dark peak that is the floor. As discussed previously, this relies on relatively weak illumination, which makes an empty trailer rather dark. However, if there is cargo nearby (in the periphery) it is relatively bright compared to the rest of the trailer floor. As shown in FIG. 14, when the white threshold is applied to the entire section, it clearly indicates where cargo is and is not present.

As the term is used herein, a “blob” is a group of adjacent pixels in an image that all have amplitude values set to a high value (such as 255) by the threshold filter in step 132. Each pixel has x and y integer coordinate values that define the pixel's position in the image. In a preferred embodiment, a first pixel in the image is adjacent to a second pixel if the x-coordinate value of the first pixel differs by no more than one from the x-coordinate value of the second pixel, or if the y-coordinate value of the first pixel differs by no more than one from the y-coordinate value of the second pixel. The algorithm of FIG. 12B “assembles” blobs of adjacent pixels by identifying threshold-filtered pixels in the image that are adjacent at least one other threshold-filtered pixel in either the x or y direction (step 134). For each blob, sums are determined of the number of adjacent pixels in the x-direction and the number of adjacent pixels in the y-direction (step 136). If the two sums are both greater than a predetermined threshold value, referred to herein as BlobThreshold, then a flag is set indicating that there is cargo present within the periphery (unmasked) area of the trailer 20 (steps 138 and 140). If either of the two sums is less than BlobThreshold, then it is assumed there is no cargo present within the periphery area of the trailer 20 (steps 138 and 142).

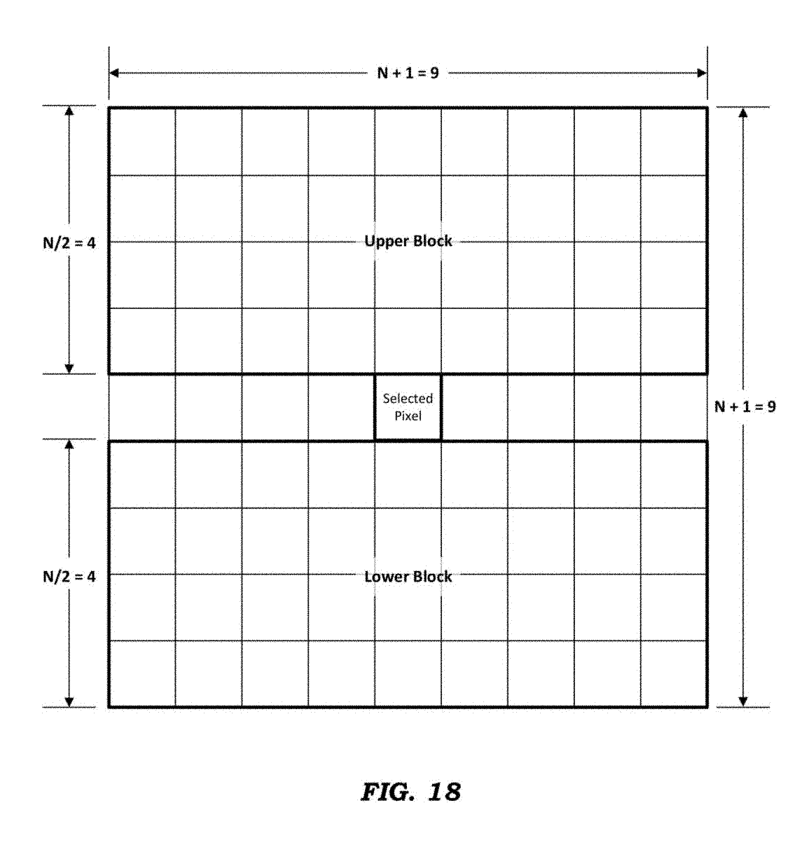

In an alternative embodiment, an algorithm is implemented that looks for large contrast changes across relatively large volumes. Steps in this algorithm are shown on the right side of FIG. 12B. After the sides have been masked (step 124), the contrast of the image is increased, such as by using histogram equalization (step 144). An x-y location of a pixel within the image is selected (step 148). If the selected pixel location is within one of the masked side areas (step 150), a new pixel location is selected (step 148). If the selected pixel location is not within a masked region (step 150), the pixel amplitude values in a block of pixels centered below the selected pixel location are averaged (step 152), and the amplitude values in a block of pixels centered above the selected pixel location are averaged (step 154). In a preferred embodiment, the blocks of pixels immediately above and below the selected pixel each comprises N+1 pixels in the x-direction by N/2 pixels in the y-direction. For example, as shown in FIG. 18, if N=8, there are 9×4=36 pixels in the lower block and 9×4=36 pixels in the upper block. If the difference in the average amplitude values between the upper and lower blocks is greater than a threshold, then the pixel amplitude at the selected pixel location is set to a high value (such as 255), thereby marking the center of the N+1×N+1 region (step 158). If the difference in the average amplitude values between the upper and lower blocks is less than a threshold, then the pixel amplitude at the selected (center) pixel location remains at its original value, and the next pixel location is selected (steps 160 to 148). Steps 148 through 158 are repeated until N+1×N+1 regions for all pixel locations in the non-masked areas of the image have been processed. Once all the N+1×N+1 regions have been processed, those regions having center-marking pixels that were set high are grouped together with adjacent regions in which the center-marking pixels were set high (step 162). If the number of adjacent N+1×N+1 regions in a group exceeds a predetermined threshold (step 164), this means there is a detected contrast change in the floor, indicating there is something there that is not the floor, which must be cargo (step 140).

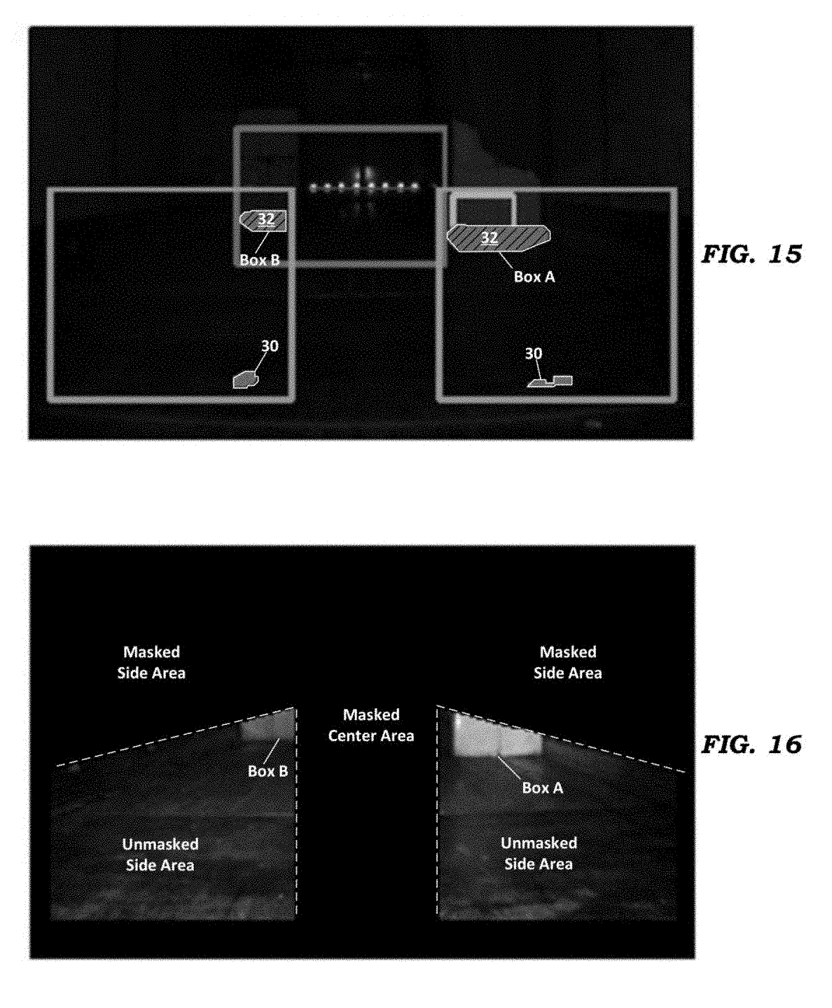

In a preferred embodiment, one or both of the algorithms of FIG. 12B are executed separately on each side of the central masked area. In the example depicted in FIGS. 15 and 16, the cross-hatched areas 32 represent groups in which the number of neighboring N+1×N+1 regions exceeds a predetermined threshold, thereby indicating places where there is a significant change in contrast. In this example, the system detects not only box A on the right, but also box B on the left. The areas 30 represent groups in which the number of neighboring N+1×N+1 regions does not exceed the predetermined threshold. These areas 30 correspond to reflections from the floor of the cargo area.

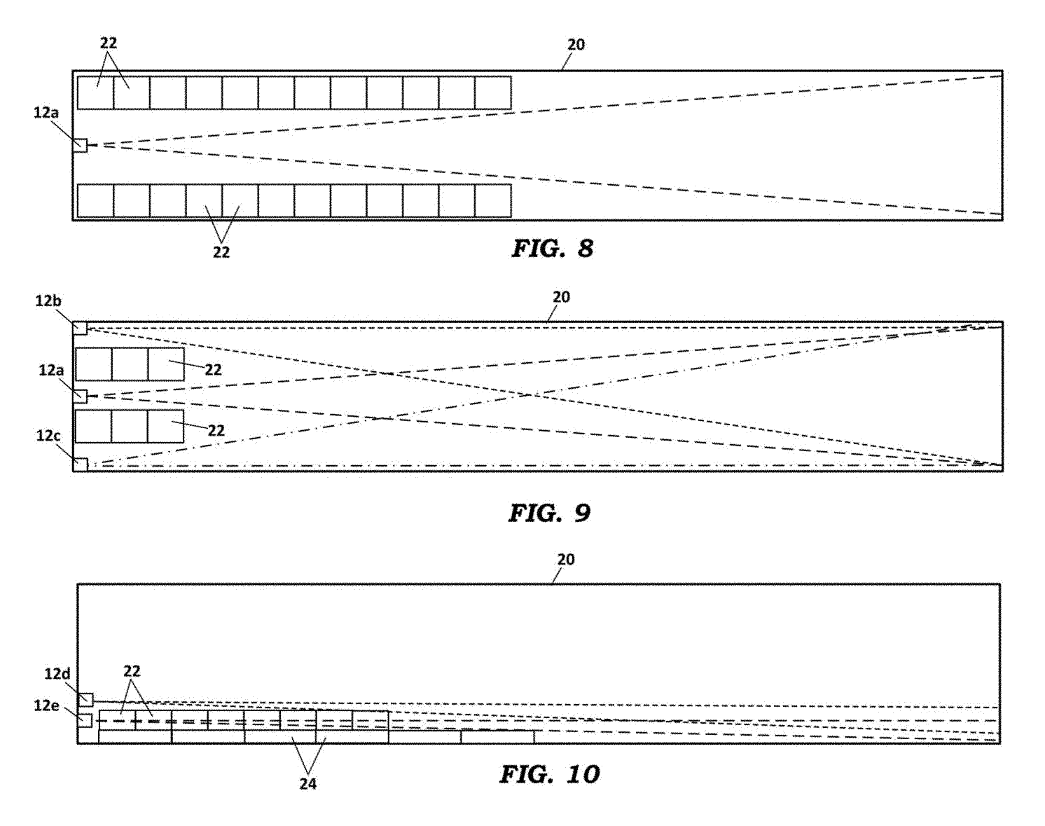

FIG. 8 depicts a top plan view diagram of a typical cargo trailer 20, such as the one shown in FIG. 2. Such trailers are typically 53 feet long (52 feet, 5 inches inside dimension), 110 inches high, and 108 inches wide. With a single camera 12a located in the center of the width of the trailer 20, all of the 2-foot square boxes 22 shown in FIG. 8 will be outside of the camera's field of view indicated by the diverging lines. In some embodiments, additional cameras are added in the corners of the nose of the trailer to cover the blind spots of the center camera. Any collection and any number of cameras may be used. Generally, increasing the number of cameras reduces the number and size of the blind spots. As shown in FIG. 9, adding two cameras 12b and 12c in the corners reduces blind spots, such that only a small section with boxes 22 is not detected. Adding two more cameras would eliminate those blind spots as well.

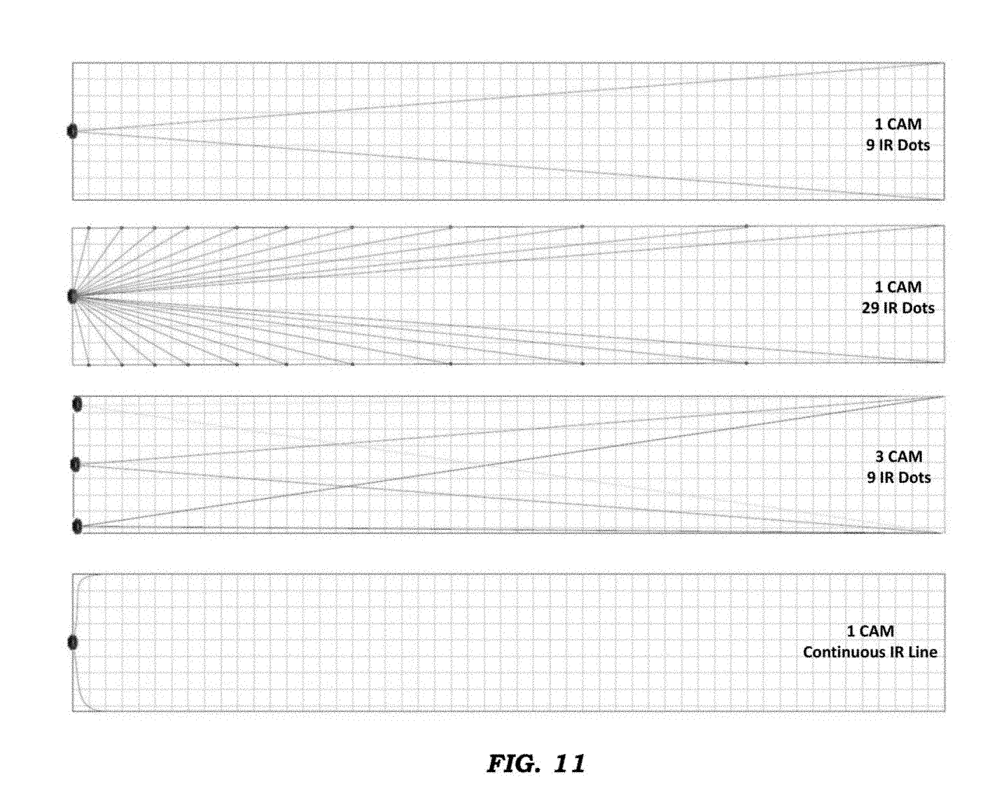

Another way to reduce blind spots using a single camera is to put a reflective or retroreflective pattern on the wall periodically down the length of the trailer. Similar to the way in which the camera sees and decodes the pattern on the door, the camera can also see and decode the pattern on the walls. A pattern that is not present or that is interrupted indicates there is cargo in that area. This technique can also be used to estimate the percentage of cargo load, assuming that cargo is loaded from the back forward and placed along the walls. Additional diagrams of exemplary camera placement schemes are shown in FIG. 11.

The vertical placement of the camera similarly determines the minimum cargo height that can be seen by the system. As depicted in FIG. 10, a camera 12d placed at 30 inches above the floor would miss a number of two-foot high boxes 22. However a camera 12e placed at 16 inches height would detect them. Similarly, the camera 12e at 16 inches height would not detect 6-inch high pallets 24. This technique also works if the cameras are placed on the door end of the trailer and the reflective pattern is on the inside of the nose of the trailer.

An additional advantage of the system described herein is that the first unloaded condition can be accurately detected. When the first unloaded condition is identified, an unloaded reference image can be captured. This allows for further image processing using more sophisticated algorithms that determine how much cargo is in the trailer.

In various embodiments, the pattern 18 may be any regular or non-regular pattern, and any set of arbitrary or regular shapes. It may also be a solid line or set of lines. In any case, the pattern 18 is selected so as to eliminate the possibility of a false positive due to the presence of a reflective piece of cargo. The pattern should be selected so that it is recognizable by the camera, and it must be complete (uninterrupted) in order to determine that the trailer is empty. The pattern can also be chosen to be a unique color or combination of color and pattern.

In preferred embodiments, the pattern 18 comprises reflective or retroreflective markers placed on the door. In some embodiments, a pattern 18 could also be placed on the floor in front of the door using retroreflective markers similar to reflective road pavement markers. Such markers may be affixed to the floor of the trailer using epoxy, similarly to how road markers are currently affixed to roads.

There may be a concern regarding some portion of the reference patterns falling off or being damaged. However, with a multiple-camera system, if all the cameras are seeing the same defect, this is a good indication that the defect is in the pattern of dots rather than that the pattern is occluded. If such a defect is detected, it can be stored and accounted for in future detection sequences.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for detecting cargo within an interior space of a cargo container, the method comprising:
(a) providing one or more imaging sensors configured for mounting within the cargo container, each having a field of view directed to an interior space of the cargo container;
(b) providing a pattern of reflective elements configured for mounting on an interior surface of the interior space of the cargo container, the pattern comprising n number of reflective elements that are within the field of view of at least one of the one or more imaging sensors;
(c) capturing one or more digital images of the interior space of the cargo container, the one or more digital images including a first portion of the interior space that includes the pattern of reflective elements, the digital image comprising pixels arranged in an x-direction and a y-direction;
(d) by application of an image processing algorithm, determining whether the n number of reflective elements are present in at least one of the one or more digital images within the field of view of at least one of the one or more imaging sensors; and
(e) if fewer than the n number of reflective elements are determined to be present based on application of the image processing algorithm, generating a notification indicating that cargo is present within the interior space of the cargo container.

2. The method of claim 1 wherein the image processing algorithm performs step (d) by:
(d1) determining a threshold amplitude value based on an amplitude value of the pixels in the digital image;
(d2) applying a threshold filter to the digital image based on the threshold amplitude value to generate a threshold-filtered image; and
(d3) determining the presence and size of each of the n number of reflective elements of the pattern detected in the threshold-filtered image.

3. The method of claim 1 wherein the reflective elements comprise dots or lines or a combination of dots and lines.

4. The method of claim 1 wherein the first portion of the interior space comprises a center portion of the cargo container.

5. The method of claim 2 wherein step (d1) comprises determining the threshold amplitude value to be equivalent to a maximum amplitude value.

6. The method of claim 2 wherein step (d2) comprises setting the amplitudes of all pixels having amplitudes that are greater than or equal to the threshold amplitude value to a high value, and setting the amplitudes of all pixels having amplitudes that are less than the threshold amplitude value to a low value.

7. The method of claim 1 wherein, if it is determined that all of the n number of reflective elements are detected by the image processing algorithm in step (d), the method further comprises:
(f) masking the first portion of the digital image;
(g) creating an intensity histogram of the digital image, excluding the first portion;
(h) locating a valley in the intensity histogram and detecting a valley amplitude value in the valley;
(i) applying a threshold filter to the digital image based on the valley amplitude value to generate a threshold-filtered image in which the amplitude of each pixel that is greater than or equal to the valley amplitude value is set to a high amplitude value;
(j) assembling pixels in the threshold-filtered image into groups, wherein each pixel in each group has the high amplitude value and is adjacent in either the x-direction or y-direction to at least one other pixel having the high amplitude value;
(k) for each group, determining a first number of pixels that are adjacent to at least one other pixel in the x-direction, and determining a second number of pixels that are adjacent to at least one other pixel in the y-direction;
(l) determining whether one or both of the first number of pixels and the second number of pixels is greater than a threshold number; and
(m) if one or both of the first number of pixels and the second number of pixels is greater than the threshold number, generating a notification indicating that cargo is present within the interior space of the cargo container.

8. The method of claim 1 wherein, if it is determined that all of then number of reflective elements are detected in the threshold-filtered image, the method further comprises:
(f) masking the first portion of the digital image;
(g) selecting a pixel of the plurality of pixels that is outside the first portion of the digital image and has not been previously selected;
(h) averaging the amplitude values of all pixels in a block of pixels disposed below and adjacent to a location of the selected pixel to determine a first average amplitude value;
(i) averaging the amplitude values of all pixels in a block of pixels disposed above and adjacent to the location of the selected pixel to determine a second average amplitude value;
(j) if a difference between the first average amplitude value and the second average amplitude value is greater than or equal to a threshold value, setting the amplitude value of the selected pixel to a high amplitude value;
(k) repeating steps (g)-(j) until all of the plurality of pixels that are outside the first portion of the digital image have been selected;
(l) assembling the selected pixels having the high amplitude value into groups, wherein each selected pixel in each group is adjacent in either the x-direction or y-direction to at least one other selected pixel having the high amplitude value;
(m) determining whether a number of selected pixels in any of the groups assembled in step (n) is greater than a threshold number; and
(n) if the number of selected pixels in any of the groups assembled in step (n) is greater than the threshold number, generating a notification indicating that cargo is present within the interior space of the cargo container.

9. A method for detecting cargo within an interior space of a cargo container, the method comprising:
(a) installing one or more imaging sensors within the cargo container, each having a field of view directed to the interior space;
(b) capturing a digital image of the interior space, the digital image comprising pixels arranged in an x-direction and a y-direction, each pixel having an amplitude;
(c) masking a first portion of the digital image;
(d) creating an intensity histogram of the digital image, excluding the first portion;
(e) locating a valley in the intensity histogram and detecting a valley amplitude value in the valley;
(f) applying a threshold filter to the digital image based on the valley amplitude value to generate a threshold-filtered image in which the amplitude of each pixel that is greater than or equal to the valley amplitude value is set to a high amplitude value;
(g) assembling pixels in the threshold-filtered image into groups, wherein each pixel in each group has the high amplitude value and is adjacent in either the x-direction or y-direction to at least one other pixel having the high amplitude value;
(h) for each group, determining a first number of pixels that are adjacent to at least one other pixel in the x-direction, and determining a second number of pixels that are adjacent to at least one other pixel in the y-direction;
(i) determining whether one or both of the first number of pixels and the second number of pixels is greater than a threshold number; and
(j) if one or both of the first number of pixels and the second number of pixels is greater than the threshold number, generating a notification indicating that cargo is present within the interior space of the cargo container.

10. The method of claim 9 wherein the first portion of the digital image includes a center portion of the cargo container.

11. The method of claim 9 wherein locating the valley in step (e) comprises locating a first valley adjacent a first peak in the intensity histogram.

12. A method for detecting cargo within an interior space of a cargo container, the method comprising:
(a) installing one or more imaging sensors within the cargo container, each having a field of view directed to the interior space;
(b) capturing a digital image of the interior space, the digital image comprising a plurality of pixels arranged in an x-direction and a y-direction, each pixel having an amplitude;
(c) masking a first portion of the digital image;
(d) selecting a pixel of the plurality of pixels that is outside the first portion of the digital image and has not been previously selected;
(e) averaging the amplitudes of all pixels in a block of pixels disposed below and adjacent to a location of the selected pixel to determine a first average amplitude value;
(f) averaging the amplitudes of all pixels in a block of pixels disposed above and adjacent to the location of the selected pixel to determine a second average amplitude value;
(g) if a difference between the first average amplitude value and the second average amplitude value is greater than or equal to a threshold value, setting the amplitude of the selected pixel to a high amplitude value;
(h) repeating steps (d)-(g) until all of the plurality of pixels that are outside the first portion of the digital image have been selected;
(i) assembling the selected pixels having the high amplitude value into groups, wherein each selected pixel in each group is adjacent in either the x-direction or y-direction to at least one other selected pixel having the high amplitude value;
(j) determining whether a number of selected pixels in any of the groups assembled in step (i) is greater than a threshold number; and
(k) if the number of selected pixels in any of the groups assembled in step (i) is greater than the threshold number, generating a notification indicating that cargo is present within the interior space of the cargo container.

13. The method of claim 12 wherein the first portion of the digital image includes a center portion of the cargo container.

14. The method of claim 12 further comprising, after step (b) and prior to step (d), applying histogram equalization to the digital image to increase the contrast of the digital image.

15. The method of claim 12 wherein the block of pixels disposed below and adjacent to the location of the selected pixel comprises an N+1 by N/2 block of pixels, in which N is an integer value greater than one.

16. The method of claim 12 wherein the block of pixels disposed above and adjacent to the location of the selected pixel comprises an N+1 by N/2 block of pixels, in which N is an integer value greater than one

17. An apparatus for detecting cargo within an interior space of a cargo container, the apparatus comprising:
a pattern of reflective elements configured for mounting on an interior surface of the interior space of the cargo container, the pattern comprising n number of reflective elements;
one or more imaging sensors configured for mounting within the cargo container having one or more fields of view that encompasses the n number of reflective elements, the one or more imaging sensors operable to capture one or more digital images of the interior space of the cargo container, the one or more digital images including a first portion of the interior space that includes the pattern of reflective elements, the digital image comprising pixels arranged in an x-direction and a y-direction; and
a processor operable to execute an image processing algorithm to determine whether the n number of reflective elements are present in at least one of the one or more digital images generated by the one or more imaging sensors,
the processor further operable to generate a notification indicating that cargo is present within the interior space of the cargo container if fewer than the n number of reflective elements are determined to be present based on execution of the image processing algorithm.

18. The apparatus of claim 17 wherein the processor is further operable to execute the image processing algorithm to:
determine a threshold amplitude value based on an amplitude value of the pixels in the digital image;
apply a threshold filter to the digital image based on the threshold amplitude value to generate a threshold-filtered image; and
determine the presence and size of each of the n number of reflective elements of the pattern detected in the threshold-filtered image.

19. The apparatus of claim 18 wherein the image processing algorithm determines the threshold amplitude value to be equivalent to a maximum amplitude value.

20. The apparatus of claim 18 the image processing algorithm applies the threshold filter by setting the amplitudes of all pixels having amplitudes that are greater than or equal to the threshold amplitude value to a high value, and setting the amplitudes of all pixels having amplitudes that are less than the threshold amplitude value to a low value.

21. The apparatus of claim 17 wherein, if the image processing algorithm detects all of the n number of reflective elements present in at least one of the one or more digital images, the processor is further operable to execute the image processing algorithm to:
mask the first portion of the digital image;
create an intensity histogram of the digital image, excluding the first portion;
locate a valley in the intensity histogram and detect a valley amplitude value in the valley;
apply a threshold filter to the digital image based on the valley amplitude value to generate a threshold-filtered image in which the amplitude of each pixel that is greater than or equal to the valley amplitude value is set to a high amplitude value;
assemble pixels in the threshold-filtered image into groups, wherein each pixel in each group has the high amplitude value and is adjacent in either the x-direction or y-direction to at least one other pixel having the high amplitude value;
for each group, determine a first number of pixels that are adjacent to at least one other pixel in the x-direction, and determine a second number of pixels that are adjacent to at least one other pixel in the y-direction;
determine whether one or both of the first number of pixels and the second number of pixels is greater than a threshold number; and
if one or both of the first number of pixels and the second number of pixels is greater than the threshold number, generate a notification indicating that cargo is present within the interior space of the cargo container.

22. The apparatus of claim 17 wherein, if the image processing algorithm detects all of the n number of reflective elements present in at least one of the one or more digital images, the processor is further operable to execute the image processing algorithm to:
mask the first portion of the digital image;
select a pixel of the plurality of pixels that is outside the first portion of the digital image and has not been previously selected;
average the amplitude values of all pixels in a block of pixels disposed below and adjacent to a location of the selected pixel to determine a first average amplitude value;
average the amplitude values of all pixels in a block of pixels disposed above and adjacent to the location of the selected pixel to determine a second average amplitude value;
if a difference between the first average amplitude value and the second average amplitude value is greater than or equal to a threshold value, set the amplitude value of the selected pixel to a high amplitude value;
repeat until all of the plurality of pixels that are outside the first portion of the digital image have been selected;
assemble the selected pixels having the high amplitude value into groups, wherein each selected pixel in each group is adjacent in either the x-direction or y-direction to at least one other selected pixel having the high amplitude value;
determine whether a number of selected pixels in any of the assembled groups is greater than a threshold number; and
if the number of selected pixels in any of the assembled groups is greater than the threshold number, generate a notification indicating that cargo is present within the interior space of the cargo container.

23. An apparatus for detecting cargo within an interior space of a cargo container that has a pattern of reflective elements on an interior surface thereof, the pattern comprising n number of reflective elements, the apparatus comprising
a processor operable to execute an image processing algorithm to determine whether the n number of reflective elements are present in a digital image that encompasses a first portion of the interior space of the cargo container, wherein the digital image comprises pixels arranged in an x-direction and a y-direction,
the processor further operable to generate a notification indicating that cargo is present within the interior space of the cargo container if fewer than the n number of reflective elements are determined to be present based on execution of the image processing algorithm.
